(19) United States
(12) Patent Application Publication
(10) Pub. No.: US 2006/0179411 A1
(43) Pub. Date: Aug. 10, 2006

(54) Real-time sharing of single user applications among multiple users

(76) Inventors: John W. Wolf, New York, NY (US); Scott A. Tacoronte, New York, NY (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/048,206

(22) Filed: Feb. 1, 2005

(51) Int. Cl. G06F 3/00; G06F 17/00; G06F 9/00

(52) U.S. Cl. 715/751

(57) ABSTRACT

Certain multiple user functionalities are provided in connection with the usage of various computer and Internet applications in a personal computer system designed for single user usage. Duplicate sets of user input devices such as keyboards and mice may be provided. Two or more users may utilize the duplicate sets of user input devices to control a single set or duplicate sets of input markers (i.e., cursors and pointers) on a common display screen. Priorities may be assigned to certain user input devices or groups of user input devices to avoid conflicts. The priorities may be assigned automatically or assigned manually by a user.

### BACKGROUND OF THE INVENTION

This invention relates to personal computer systems. More particularly, this invention relates to personal computer systems in which multiple users may manipulate a single application shown on a common display.

In known multiple user systems, for example, video game systems, separate user input devices, such as game consoles, are provided to enable multiple users to interact with an application on a single screen. To support functionalities of the multiple user input devices, these systems typically require applications that are specifically designed for multiple users. These systems also often have numerous specific hardware demands such as demand for a specific number of compatible game consoles.

While multiple user systems designed for very specific needs have been available in the market as described above, there is a growing yet unaddressed demand for multiple user functionalities in systems that are designed for single user usage.

As an example, many homes today have only a single personal computer that is shared among multiple family members. It is not unusual for two or more family members to wish to view and interact with a single application on the personal computer (e.g., an email application) simultaneously. Currently, in order to do this, the two users must share the use of a single set of user input devices, such as a keyboard and mouse. Essentially, the two users must interact with the application like a single user. Needless to say, this approach can be frustrating. It requires the users to sit in close proximity to each other, involves the constant passing of often-wired hardware devices between the individuals, etc. When the application involves editing of documents, there is the added difficulty of, for example, keeping track of the locations of edits, avoiding mistypes in the process of passing the devices, etc.

Accordingly, it is an object of the present invention to provide certain multiple user functionalities in personal computer systems that are designed for a single user.

### SUMMARY OF THE INVENTION

It is an object of the present invention to provide certain multiple user functionalities in a personal computer system designed for single user usage.

More specifically, in some embodiments of the present invention, duplicate sets of user input devices such as keyboards and mice are provided. Two or more users may use the duplicate set of user input devices to interact with a single application shown on a common display.

In some embodiments of the present invention, the two or more users may utilize the duplicate sets of user input devices to control duplicate sets of input markers (i.e., cursors and pointers) on the common display screen. In these embodiments, the input markers associated with the different users may differ in appearances, for example, in color, textual, etc. In some of these embodiments, software may be introduced to detect and prevent conflicts among action requests from the different users.

In some embodiments of the present invention, the two or more users may utilize the duplicate sets of user input devices to control the same set of input markers. In these embodiments, one set of the user input devices may be given priority in interacting with the application as primary input devices. Alternatively, priority may be assigned to the devices on a dynamic basis.

In some embodiments of the present invention, a user may be allowed to group certain user input devices together as a set and assign priority to them as a group.

In some embodiments of the present invention, a user may be given the opportunity to specify what range of functionalities a particular user input device is allowed to perform.

In some embodiments of the present invention, like types of user input devices (i.e., keyboards with other keyboards and mice with other mice) may be modified so that they may couple to each other in a chain fashion.

The attainment of the foregoing and related objects, advantages and features of the inventions of the present invention should be more readily apparent to persons skilled in the art, after review of the following detailed description of the invention, taken together with the drawings.

### BRIEF DESCRIPTION OF THE DRAWINGS

FIG. 1 is a schematic representation of duplicate sets of user input devices coupled to a single personal computer in accordance with an embodiment of the present invention;

FIG. 2 is a schematic representation of multiple keyboards and mice directly coupled to standard personal computer ports in accordance with an embodiment of the present invention;

FIG. 3 is a schematic representation of multiple keyboards and mice coupled to an in-home hub that is in turn coupled to a personal computer in accordance with an embodiment of the present invention;

FIG. 4 is an illustrative configuration menu screen that enables a user to set priority to various user input devices in accordance with an embodiment of the present invention;

FIG. 5 is an illustrative configuration menu screen that enables a user to enable/disable the functionalities of a particular user input device in accordance with an embodiment of the present invention; and

FIG. 6 is a schematic representation of an auxiliary keyboard and an auxiliary mouse respectively connected to a primary keyboard and a primary mouse, which are connected to a personal computer in accordance with an embodiment of the present invention.

### DETAILED DESCRIPTION OF THE INVENTION

Personal computers and most of the consumer applications that run on them are generally designed for single user usage. Most computers are sold with only a single set of user input devices (i.e., keyboard and mouse). One high level objective of the present invention is to expand the capability of the traditional personal computer through minimal modifications to its hardware and software so that multiple users may comfortably share the use of a single application on a single computer to, for example, browse the internet or edit a document, simultaneously.

In order to achieve a level of comfort and independence while sharing the application and computer, it is essential that separate user input devices be provided for each user (e.g., each user should have, at a minimum, his own mouse or his own keyboard, or both). The following description describes user input devices mainly in the forms of keyboards and mice. While these are the most common types of user input devices associated with personal computers, it should be understood by those skilled in the art that any other suitable user input devices that may be used in connection with a personal computer is within the scope of this application. For example, each user could be provided with a touch pad that accepts written inputs (not shown) for the input devices.

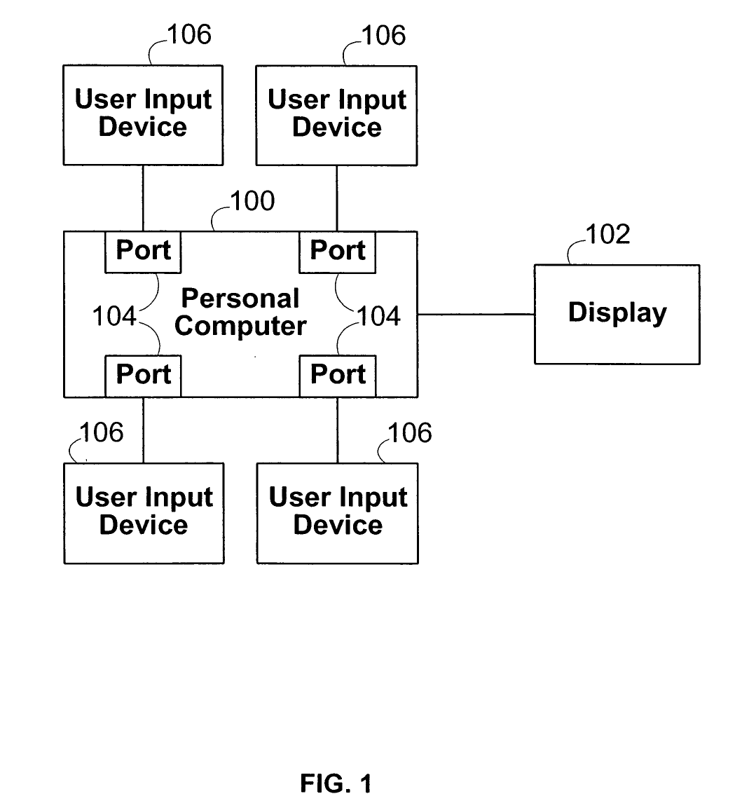

FIG. 1 is a schematic representation of personal computer 100 that includes duplicate sets of keyboards and mice coupled to a single personal computer. In this circumstance, personal computer 100 may be any suitable conventional computer. Personal computer 100 may be coupled to a single display 102 (or multiple displays may be used). Display 102 may be a computer monitor, a television, or any other suitable device for displaying data generated by personal computer 100.

Personal computer 100 may include communication ports 104, through which one or more user input devices 106 may be coupled. User input devices 106 may include one or more sets of keyboards, mice, and any other suitable input devices compatible with personal computer 100.

Communication ports 104 may be any suitable ports for effecting communication between a peripheral user input device 106 and personal computer 100. In a conventional computer system, communication ports 104 may include serial ports, parallel ports, Universal Serial Bus (USB) ports, ports dedicated to the connections of keyboards and mice, and any other suitable communication ports. Methods for creating such connections from personal computer 100 to user input devices 106 are well known in the art and are thus not described in detail here.

FIG. 1 is merely illustrative of an arrangement in accordance with the present invention. Various other suitable arrangements may be used in its place. For example, while FIG. 1 shows two pairs of user input devices (each of which may represent a keyboard and a mouse), computer system 100 may be accomplished by providing each user with a mouse, but only a single keyboard.

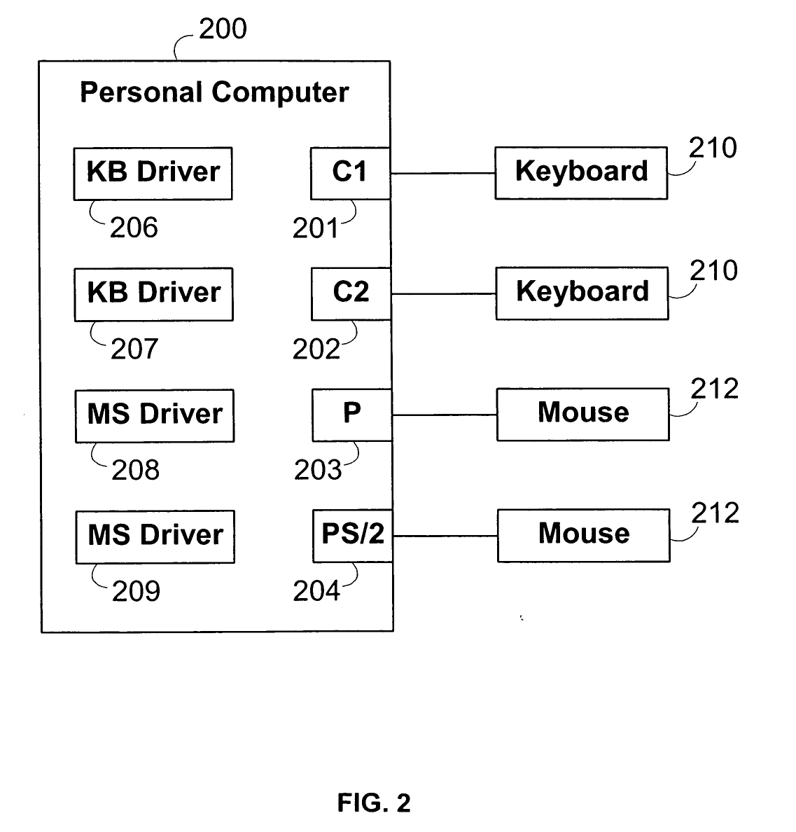

In some embodiments of the present invention, it may be desirable to provide separate input markers (i.e., cursors) on display screen 102 that correspond to each of the multiple users. For example, when two users simultaneously edit a text document, it may be desirable to provide separate cursors and/or other markers so their respective portions may be easily identified. These separate cursors should be readily identifiable, such as by being different colors, so each user can readily locate his cursor. To achieve the dual display of input markers, a setup as shown in FIG. 2 may be used in accordance with some embodiments of the present invention.

FIG. 2 is a schematic representation of personal computer 200 which includes two sets of keyboards 210 and mice 212, each of which is directly coupled to one of four standard ports C1 201, C2 202, PARALLEL 203, and PS/2 204. The four ports may be any combination of standard ports that are commonly found in connection with a personal computer (e.g., port 203 could be a USB port instead of a parallel port). In connection with this setup, separate device drivers 206-209 may be installed that correspond to each of the user input devices. Each device driver may be capable of producing an on-screen marker and affecting a full range of separate device functionalities in connection with the device in the specified application.

FIG. 2 is merely illustrative of an arrangement in accordance with the present invention. Various other suitable arrangements may be used in its place.

Most applications designed for single user usage do not have the capability of resolving conflicts that may possibly arise from multiple user usage. For example, a word processing application generally is not designed to handle conflicts caused by two different users trying to edit the same document at the same time. One advantage of the present invention is that the application need not change to accommodate multiple users. Instead circuitry and/or software may be provided to resolve such conflicts through the device drivers.

For example, keyboard driver 208 may have the capability of preventing the keyboard connected to it from overriding another keyboard if it detects that another keyboard is editing in the current program. In some embodiments of the present invention, the action request of the keyboard may be temporarily queued in a cache until the other keyboard stops typing for a period of time. Alternatively, the user may be warned in various fashions that no typing is allowed at this time. Mouse functionalities may be similarly prohibited or allowed to avoid conflicts.

Of course, this is not to say that the application itself may not be modified to accommodate multiple users. It is certainly within the spirit of the present invention that applications may be modified, for example, in the form of plug-in, to allow multiple user functionality.

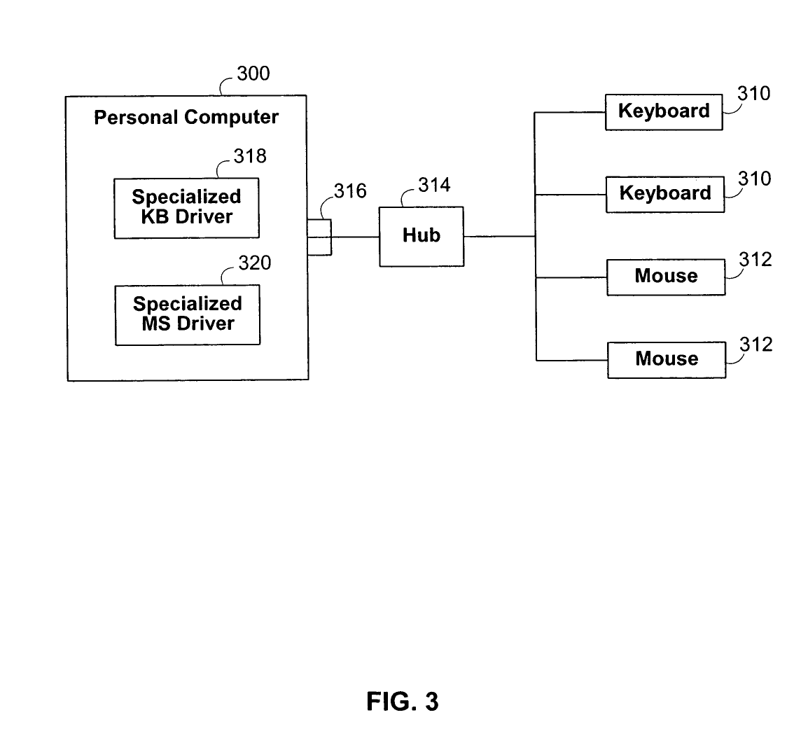

In some embodiments of the present invention, a hub may be used to provide an alternative method of coupling the user input devices to the personal computer. The hub tends to be a more practical method to achieve such connectivity when a larger number of users are involved. For example, in a classroom setting, it may be very desirable to allow all the students, each having his or her own user input devices, to connect to one or more hubs, which in turn connect them to a single application such as a PowerPoint presentation. FIG. 3 shows such an arrangement. In this arrangement, the teacher could control how much ability each student has to access and modify a common document the class is currently working on using a single computer.

FIG. 3 is a schematic representation of personal computer 300 which includes multiple keyboards 310 and multiple mice 312 coupled to an in-home hub 314 that is coupled to personal computer 300. In this scheme, hub 314 may include a number of ports similar to the ones described above in connection with personal computer 200 of FIG. 2. Hub 314 may become coupled to personal computer 300 through a single port 316, which may be, for example, a USB port.

The fact that this example includes numerous keyboards 310 and mice 312 coupled to personal computer 300 through hub 314 places computer 300 outside the capability of conventional device drivers. Accordingly, it may be desirable to provide a set of specialized keyboard and mice drivers 318 and 320 in connection with this arrangement. Specialized keyboard and mice drivers 318 and 320 may be capable of distinguishing inputs from the individual keyboards 310 and mice 312, and thus would be capable of generating multiple input markers for each of the keyboards 310 and mice 312 on the screen. Such specialized drivers 318 and 320 may become installed on personal computer 300, for example, through the use of a Compact Disc, through a download from the Internet, or through any other suitable means for obtaining software (not shown).

FIG. 3 is merely illustrative of an arrangement in accordance with the present invention. Various other suitable arrangements may be used in its place.

While separate input markers may be sometimes desirable to distinguish inputs among the multiple users, they are not always practical. In certain instances, it may be more desirable to allow the various users to share a single set of input markers. As an example, in a presentation, while it may be desirable for multiple users to be able to manipulate a pointer on the screen, it may be essential that only a single pointer is shown on screen. This may help avoid audience confusion as to where to focus their attention. As another example, in a classroom, having a large number of student users, numerous input markers may partially block information on the screen.

Under such circumstances, some level of configuration control may be provided in accordance with the present invention, which may allow a primary user to specify the range of allowable functionalities for each of the other various user input devices. Such configuration control may be provided, for example, in the form of additional software for coordinating one or more separate device drivers 206-209, in the form of additional software capability of specialized device drivers 318 and 320, or in any other suitable form in accordance with any other suitable arrangements.

In some embodiments of the present invention, this type of configuration may be automatic. As an example, the configuration software may assign supremacy to user input devices connected to specific ports of any of personal computers 100, 200 or 300, or hub 314. Once a superior device is identified, any time a request is detected from the superior device, all other requests from any other devices are suppressed. For example, when a user begins to type on a superior keyboard, no other keystrokes on any other keyboards are acknowledged or registered by the system.

In some embodiments of the present invention, the superiority assignment may also be applied across devices. For example, any one of a superior set of user input devices (e.g., a set of superior keyboard and mouse) may suppress the requests from any devices that are not within the superior set, regardless of whether the device suppressed is of the same type as the device that is taking superiority. For instance, when a mouse belonging to a superior set moves, it terminates any typing that may be done on a keyboard that is not also part of the superior device set.

In some embodiments of the present invention, priority may be given automatically to the user input devices in a dynamic manner. According to one suitable implementation, action requests from various user input devices may be queued on a first come first served basis. Specifically, once a device becomes active, no other requests from any other device in general or any other device of the like type may be executed until the activated device becomes inactive again.

In some embodiments of the present invention, a user may be allowed to manually assign superiority to certain user input devices in a configuration process. For example, once all the available devices have been coupled to and identified by the personal computer, a menu screen may be presented to the user, enabling the user to specify superiority of the devices. In some embodiments, the user may additionally be allowed to specify functions that a particular device may or may not perform.

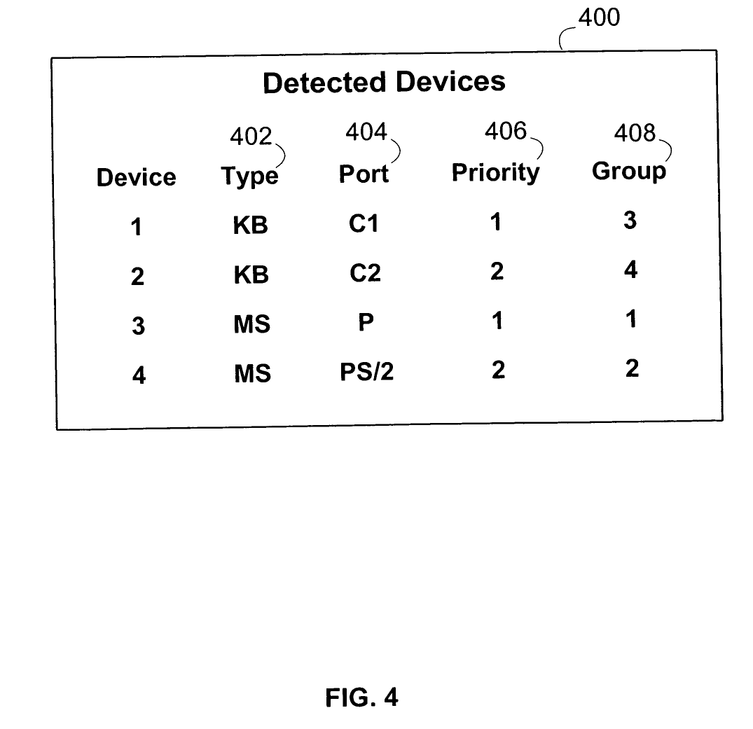

FIG. 4 shows an illustrative configuration of user interface 400 in accordance with the principles of the present invention that may be used to allow the users to make the type of priority or superiority specifications discussed above. In a list or in any other suitable format, user interface 400 may display, for each identified user input device, its type 402 and connection port 404. In a separate priority column 406, the users may be given the opportunity to input ranking for the user input devices. Priority column 406 may be implemented to avoid conflicts arising from double designation. For example, the users may be prevented from giving the same ranking to more than one device. This ranking may later be used to determine superiority of the action requests from the various user input devices in place of the automatic assignment discussed above.

In some embodiments of the present invention, the user may also be allowed to group certain user input devices together as a set and assign priority to them as a group. In one suitable implementation, an additional group column 408 may be displayed via configuration interface 400. The users may, for example, group user input device 1 with user input device 2 by typing the device number 2 into suitable portion corresponding to user input device 1 in column 408. To avoid conflicts, the portion in column 408 that corresponds to device 2 may be automatically filled in with information for device 1. The superiority information in priority column 406 that corresponds to both devices 1 and 2 may become synchronized in response to the grouping.

FIG. 4 is merely illustrative of an arrangement in accordance with the present invention. Various other suitable arrangements may be used in its place.

In some embodiments of the present invention, a primary user may also be given the opportunity to specify what range of functionalities a particular user input device is allowed to perform. As an example, in a class where each student is given a separate set of user input devices, a teacher may choose to forbid the student keyboard from making any changes to a document. In this way, a student may point to locations on a common screen in class, but is unable to make any changes.

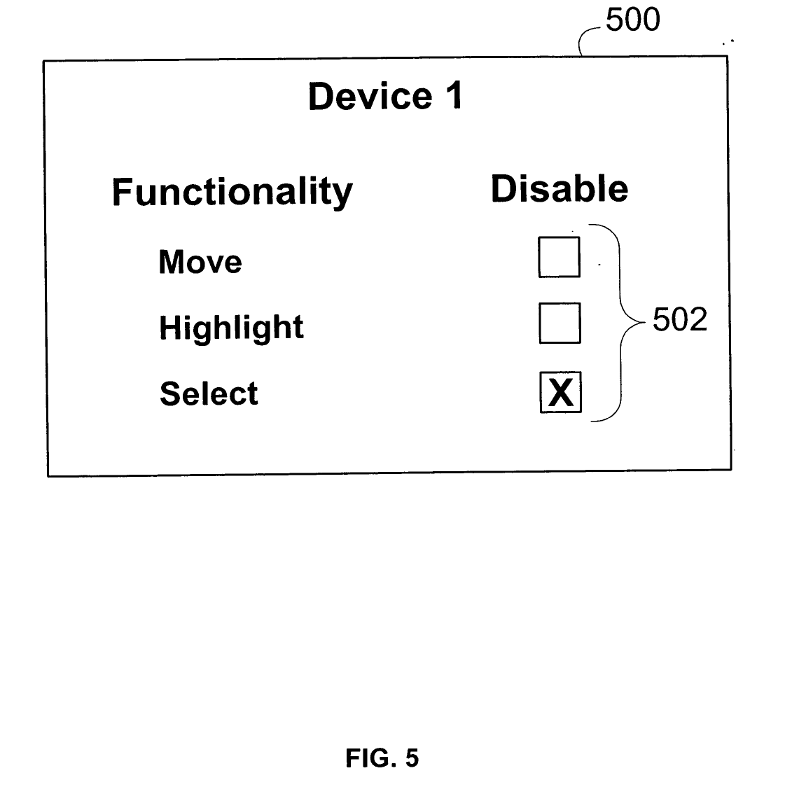

In one suitable implementation, the primary user may be given this opportunity to limit the functionalities of user input devices during a configuration step. For example, the user may select a user input device via user interface 400. This may cause another interface 500, shown in FIG. 5, to appear. The various functionalities of the selected device may be displayed in a list format in screen 500. A user may select to enable or disable a particular functionality of the selected device, for example, using checkboxes 502, which correspond to the functionalities of the selected device. Certain functionalities may be enabled for the device as a default.

FIG. 5 is merely illustrative of an arrangement in accordance with the present invention. Various other suitable arrangements may be used in its place.

In the embodiments discussed above, conventional user input devices are used. If desired, the present invention may also be implemented using modified user input devices. Utilizing modified user input devices may have the advantage of achieving multiple user functionalities through existing device drivers that are designed to support only a single device.

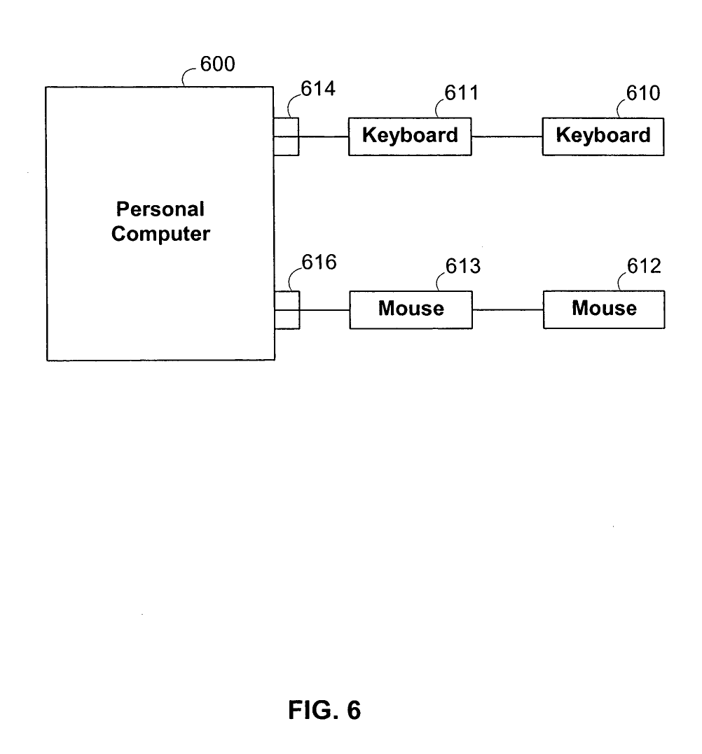

In some embodiments of the present invention, certain user input devices may be modified so that other like type of devices may couple to it in a chain fashion. FIG. 6 shows personal computer 600 which includes such a setup where one keyboard 610 is connected to another keyboard 611, which is conventionally connected to personal computer 600 via an interface 614. FIG. 6 also shows one mouse 612 connected to another mouse 613, which is conventionally connected to personal computer 600 via interface 616.

In this type of setup, keyboard 610 and mouse 612 may be conventional keyboard and mouse, while keyboard 611 and mouse 613 may have their respective hardware modified so that like devices may be connected to computer 600 through them. In addition, the firmware of keyboard 611 and mouse 613 may be modified so that commands originated from personal computer 600 may be communicated to each device connected in the chain and so they may control data sent to personal computer 600 from the auxiliary devices connected to them.

In this type of setup, the hardware and firmware of the user input device that is directly connected to the personal computer are the only modified components. This setup also has the added advantage of allowing a modified or dominant directly connected user input device to dynamically regulate the functionalities of the other like user input devices coupled to it.

For example, a modified dominant keyboard may have upon it special keys for preventing an auxiliary keyboard connected to it from being able to send out any commands to the personal computer, for preventing functionalities of certain portions of the auxiliary keyboard (i.e., the enter key) from functioning, for invoking a mini menu, which a user may use to specify which functionalities of the auxiliary keyboards are to be enabled or disabled, and for performing any other suitable functions. In a similar fashion, a modified dominant mouse may have upon it special buttons for performing similar tasks in connection with any auxiliary mouse that is connected to it.

Using the systems and methods described above, multiple users may comfortably share an application such as a word processing application or an Internet application that is designed for single user usage.

The foregoing is merely illustrative of the principles of the present invention. Various modifications can be made by those skilled in the art without departing from the scope and spirit of the invention.

What is claimed is:

1. A personal computer system for supporting duplicate user input devices in an application designed for single user usage, the personal computer system comprising:
a first user input device connected to the system for use by a first user;
a duplicate user input device connected to the system for use by a second user, wherein the duplicate user input device is of the same type as the first user input device;
a display;
a processing unit capable of running the application designed for single user usage;
circuitry that interfaces with the application based on inputs received from both the first user input device and the duplicate user input device, wherein the circuitry combines the inputs received and interacts with the application as if a single user were providing inputs to the application.

2. The personal computer system of claim 1, wherein the circuitry generates a first input marker on the display for the first user input device and a second input marker for the duplicate user input device.

3. The personal computer system of claim 2, wherein the first input marker and the second input marker are different in appearance.

4. The personal computer system of claim 1, wherein the circuitry selectively ignores the inputs from one of the first user input device and the duplicate user input device.

5. The personal computer system of claim 4, wherein the circuitry decides which user input device to ignore based on a priority system.

6. The personal computer system of claim 5, wherein the system further comprises:
an interface that permits one of the first user and the duplicate user to specify the rules of the priority system.

7. The personal computer system of claim 1, wherein the system further comprises:
an interface that allows one of the first user and the duplicate user to disable selected functions of either of the first user input device and the duplicate user input device.

8. The personal computer system of claim 1, wherein the first user input device and the duplicate user input device are keyboards.

9. The personal computer system of claim 1, wherein the first user input device and the duplicate user input device are computer mice.

10. The personal computer system of claim 1, wherein the first user input device and the duplicate user input device are touch pads.

11. A personal computer system that operates application programs designed for use by a single user at a time, the system comprising:
a first computer mouse;
a second computer mouse;
a computer display;
processing circuitry that runs a selected single user application program; and
interface circuitry, coupled to both the first computer mouse and the second computer mouse, that accepts inputs from both computer mice, analyzes those inputs and converts those inputs to a single set of control inputs that are provided to the processing circuitry to operate the single user application program.

12. The personal computer system of claim 11, wherein the first computer mouse is physically connected to the interface circuitry.

13. The personal computer system of claim 11, wherein the first computer mouse is coupled to the interface circuitry via a wireless connection.

14. The personal computer system of claim 11, wherein the first computer mouse is connected to the interface circuitry via a hub.

15. A personal computer system that operates application programs designed for use by a single user at a time, the system comprising:
a first keyboard;
a second keyboard;
a computer display;
processing circuitry that runs a selected single user application program; and
interface circuitry, coupled to both the first keyboard and the second keyboard, that accepts inputs from both keyboards, analyzes those inputs and converts those inputs to a single set of control inputs that are provided to the processing circuitry to operate the single user application program.

16. A personal computer system that operates application programs designed for use by a single user at a time, the system comprising:
a first keyboard;
a second keyboard;
a first computer mouse;
a second computer mouse a computer display;
processing circuitry that runs a selected single user application program;
first interface circuitry, coupled to both the first keyboard and the second keyboard, that accepts inputs from both keyboards, analyzes the keyboard inputs and converts the keyboard inputs to a first single set of control inputs that are provided to the processing circuitry to operate the single user application program; and
second interface circuitry, coupled to both the first mouse and the second mouse, that accepts inputs from both mice, analyzes the mice inputs and converts the mice inputs to a second single set of control inputs that are provided to the processing circuitry to operate the single user application program.

17. A method for controlling a single user application running on a personal computer comprising:
receiving inputs from a first user input device;
receiving inputs from a duplicate user input device that is substantially similar to the first user input device;
analyzing the received inputs to determine a priority sequence for the received inputs; and
providing the received inputs to the single user application in accordance with determined priority sequence.

18. The method of claim 17, wherein the received inputs are provided by one of a first computer mouse and a duplicate computer mouse.

19. The method of claim 17, wherein the received inputs are provided by one of a first keyboard and a second keyboard.
